(19) United States
(12) Patent Application Publication
(10) Pub. No.: US 2023/0367287 A1
(43) Pub. Date: Nov. 16, 2023

(54) NUMERICAL CONTROL CODE CONVERSION FOR DETERMINING ESTIMATED CONDITIONS OF A FINISHED THREE-DIMENSIONAL PRINTED PART

(71) Applicant: Essentium, LLC, Pflugerville, TX (US)

(72) Inventors: Jorge Arturo Mijares Tobias, Puebla (MX); Iris Gisey Euan Waldestrand, Puebla (MX); Matthew Skolaut, Houston, TX (US); Carl Eckhardt, Austin, TX (US); Chad Eichele, Lake Forest, CA (US); William Jack MacNeish, III, Santa Ana, CA (US)

(21) Appl. No.: 18/245,584

(22) PCT Filed: Sep. 20, 2021
(86) PCT No.: PCT/US21/51040

§ 371 Date: Mar. 16, 2023

Related U.S. Application Data
(60) Provisional application No. 63/081,640, filed on Sep. 22, 2020.

(51) Int. Cl. G05B 19/408; B29C 64/393; G05B 19/4099; G05B 19/41

(52) U.S. Cl. CPC G05B 19/4083; B29C 64/393; G05B 19/4099; G05B 19/41; B33Y 50/02

(57) ABSTRACT

A system for determining estimated conditions of a finished printed part generated by a three-dimensional printer includes one or more processors for receiving one or more numerical control code files and machine parameters. The system includes a memory coupled to the one or more processors that stores data comprising a database and program code that, when executed by the one or more processors, causes the one or more processors to parse the one or more numerical control code files into parsed numerical control code files. The one or more processors determine an updated machine state of the three-dimensional printer based on the parsed numerical control code files and the machine parameters and combine the updated machine state with the parsed numerical control code files to create one or more nodes. The system receives one or more operator inputs and creates one or more print analyses.

### CROSS-REFERENCE TO RELATED APPLICATIONS

This application claims priority to U.S. Application No. 63/081,640 filed on Sep. 22, 2020, the teachings of which are incorporated herein by reference.

### FIELD

The present disclosure is directed to a system and method for determining estimated conditions of a finished printed part generated by a three-dimensional printer based on one or more numerical control code files, machine parameters of the three-dimensional printer, and one or more operator defined inputs. The estimated conditions of the finished printed part allow for an operator to analyze the numerical control code files and modify various machine parameters to improve machine performance and part quality, without the need to operate the three-dimensional printer.

### BACKGROUND

Three-dimensional printers utilize a set of instructions, typically in the form of a computer numerical control programming language, to direct the movements of the print head when depositing filament on the print platform. While the print instructions may be manually programed, print instructions are often automatically programmed through computer aided machining (CAM) software that derives the geometry code, which is referred to as g-code, from a computer aided design (CAD) file. For three-dimensional printing, the CAD file representing the three-dimensional object is manipulated by the slicing software to define the printed object scale relative to the design scale, slice the three-dimensional object into a number of layers with a motion path based on, for example, an assumed trace height and width, divide the object up into chords or segments, define infill, and determine exposed wall thicknesses. Then for each layer, a series of actions is created for moving the print head and depositing the filament. Such actions include defining a home position, starting and stopping locations, distances of travel, rates of travel, interpolation of mid-points, returns to the home position, extrusion rate, etc. The series of actions are codified as print instructions as g-code or another form of numerical control code. These instructions are then provided to and executed by the three-dimensional printer.

G-code, which is output from a slicer that processes a three-dimensional object into layers for a target three-dimensional printing system, may not be in an optimized condition. The series of actions described above do not allow for optimizing printing conditions that may ultimately affect part quality before operation of a three-dimensional printer. For example, a programmer entering data does not presently have the capability to modify features such as velocity, time, temperature and flow rate and obtain an analysis of the impacts of each change without first entering the G-code file data into a three-dimensional printer and performing a three-dimensional print operation.

While the methods of generating a G-code print file work to achieve their intended purpose, there is a need for new and improved systems and processes for three-dimensional printing.

### SUMMARY

According to several aspects, the present disclosure relates to a numerical control language conversion process for systems analysis and for optimizing three-dimensional printing process parameters. The process includes inputting a numerical control language file data for printing a three-dimensional object, from any three-dimensional Slicer or generator, to a processor for parsing the computer numerical control code and then use a machine state approach with the specific machine parameters to output the machine state at every motion command or control instruction. The processed output data is available in a software toolbox wherein analyses of the data and machine response to the control commands may be conducted without requiring operation of the three-dimensional printing system.

In further aspects, the analyses toolbox includes motion state of the machine over time, such as real velocities, corner velocities and average velocities per axes or path, which could be used to evaluate and improve the selection of machine parameters and motion control strategies.

In further aspects, the analyses toolbox includes time analysis of the numerical control language which could provide total print job time, time per numerical control language command, time per layer, and total travel-time, which could be used to evaluate and improve the selection of slicing strategies and slice parameters.

In further aspects, the analyses toolbox allows inspection of numerical control language to validate the compatibility with the three-dimensional printing system and to prevent commands that exceed the limits of the system. For instance, commands that exceed the limits of the system may include syntax errors, unsupported commands and high temperatures commands that will cause material degradation and jamming, low temperatures commands that can cause cold extrusion and poor layer adhesion, incorrect motion commands that exceed the limits of the machine kinematics or prevent tool head collisions.

In further aspects, the analyses toolbox includes the extrusion rate which may be used to adjust extrusion temperature base on the material characterization, which includes a relation of the extrusion rate vs extruder temperature.

In additional aspects, the analyses toolbox includes a comparison of the real velocity of a print head and the commanded velocity of the print head or per axis.

In further aspects, the analyses include nozzle temperature over time.

In additional aspects, the analyses include an identification of non-ideal temperatures based on a material characterization.

According to several aspects, the analyses include an analysis of non-ideal velocity of a print head. As for example, the geometric constraints and machine kinematics will define the maximum velocities that could be reached on those sections.

According to several aspects, the present disclosure relates to a system and method for analyzing data in advance of printing a three-dimensional object. The system includes a print head carried by an x-y carriage, including a heated nozzle and a feed motor that could be a direct or a Bowden system, a heated bed, a mechanism to move on the z-axis either by moving the x-y carriage or the heated bed, and a processor control system.

In further aspects, the process includes a software package used in a stand-alone application.

### BRIEF DESCRIPTION OF DRAWINGS

The drawing described herein are for illustration purposes only and are not intended to limit the scope of the present disclosure in any way.

FIG. 1 illustrates a facet of a three-dimensional printer including a print head carried by an x-y carriage, according to an exemplary aspect of the present disclosure;

FIG. 2 illustrates an aspect of a print head, a print platform, a cooling fan and a three-dimensional printed object on the print platform, according to an exemplary aspect;

FIG. 3 illustrates a flow diagram of a first portion of a processor defining a process for applying the machine parameters according to an exemplary aspect of the present disclosure;

FIG. 4 illustrates a flow diagram of a second portion of the processor defining a node toolbox that contains analyses modules according to an exemplary aspect of the present disclosure; and

FIGS. 5A and 5B illustrate graphs of an exemplary pattern of short movements of the print head according to an exemplary embodiment of the present disclosure.

### DETAILED DESCRIPTION

The present disclosure relates to a process and method for analyzing a computer numerical control code, for example for use in a system for three-dimensional printing. The process and method take into account control commands and machine parameters to assist in the printing process development without the need of printing.

As noted above, three-dimensional printers utilize a set of instructions, typically in the form of a computer numerical control programming language, to direct the movements of a print head when depositing filament on the print platform. In one embodiment, the computer numerical control code is G-code, however, it is to be appreciated that other numerical control codes may alternatively be used as well. A computer aided design (CAD) file is used to develop a three-dimensional part which is then passed through a slicer software or a computer aided machining (CAM) software to generate the G-code. In aspects, the processes are coded or embodied by one or more of a number of programming languages including, but not limited to, at least one of the following: C #, C++, Python and Java.

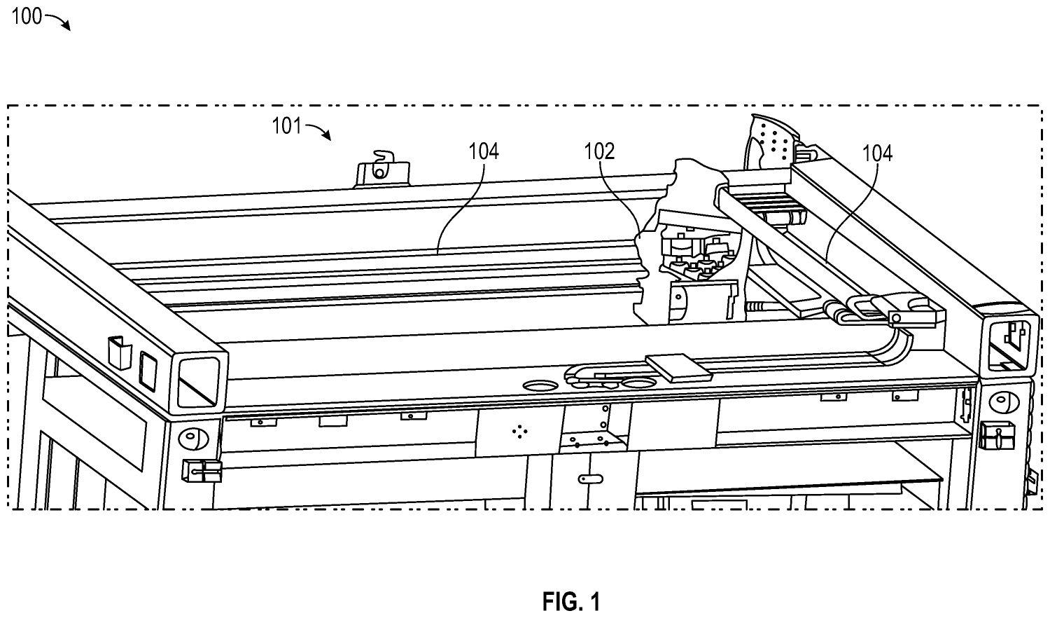

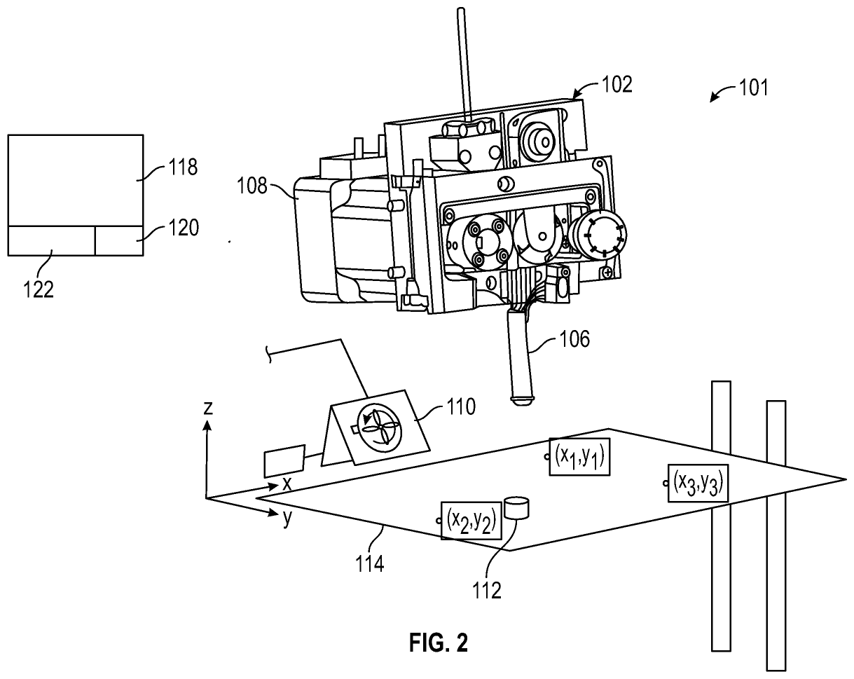

FIGS. 1 through 2 illustrate an aspect of a system 100 for printing three-dimensional objects. The system 100 includes a three-dimensional printer 101. The three-dimensional printer 101 includes a print head 102 carried by an x-y carriage 104. The print head 102 includes a heated nozzle 106 and a feed motor 108. The system 100 may further include a fan 110 for cooling the heat brake of the heated nozzle 106 and printed three-dimensional object 112. A print platform 114 is further provided upon which the three-dimensional object 112 is printed. The print platform 114 is moveable in the z-direction relative to the print head 102 to accommodate layers of extruded filament as the three-dimensional object 112 is printed. Operation of the system 100 including the print head 102, the carriage 104, the nozzle 106, the feed motor 108, the fan 110 and the print platform 114 are controlled from commands received from a processor 118.

According to several aspects, the processor 118 includes one or more processors 120, which in exemplary aspects are microprocessors. The processor 118 receives static computer numerical control code such as, for example, G-code files and includes hardware, firmware, and software for parsing, analyzing, and optimizing the numerical control language and provides an optimized executable code which may then be loaded as low-level servo controller optimizations for use by the three-dimensional printer 101. The processor 118, in exemplary aspects, may reside in a computer independent of the three-dimensional printer 101 and the output is provided to the three-dimensional printer 101, or the processor 118 may reside within the three-dimensional printer 101 itself. Where more than one processor 120 is present in the processor 118 the processors 120 perform distributed or parallel processing protocols and the processors 120 may include, for example, application specific integrated circuits, a programmable gate array include a field programmable gate array, a graphics processing unit, a physics processing unit, digital-signal processor, or a front-end processor.

The processor 118 also includes or accesses information, stored in a memory 122 with which the processor 120 is operatively coupled, regarding the filament materials which may be printed with the three-dimensional printer 101. Memory is understood as a physical device capable of storing information temporarily, such as in the case of random-access memory, or permanently, such as in the case of read-only memory. Representative physical devices include hard disk drives, solid state drives, optical discs, or storage accessible through the cloud over networks.

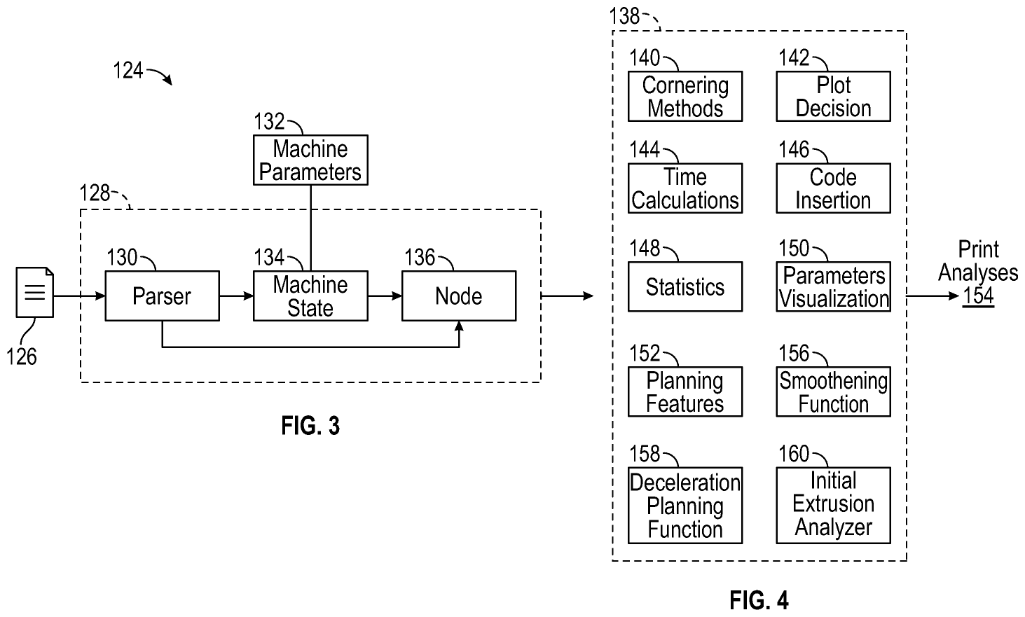

With reference to FIG. 3, an analyses tool 124 receives numerical control language as part of one or more numerical control code files 126 in a first portion 128, which is sent through a parser 130. Machine parameters 132 such as velocity, time, acceleration, temperature, motion, and flow rate are entered into the first portion 128 of the analyses tool 124 and are used together with an output from the parser 130 to update a machine state 134. An output from the updated machine state 134 is used to create a node 136 which is defined as a sum of the updated machine state plus the output of the parser 130. The node 136 contains data that can be extracted to determine a plurality of motion planning parameters of the three-dimensional printer 101 such as, but not limited to, a time to produce a line, a quantity of head movements, head direction, time to print a line, maximum velocities at corners, and the like.

With reference to FIG. 4 and again to FIG. 3, the node 136 from the first portion 128 is passed to a second portion 138 also defined as a node toolbox. The second portion 138 provides multiple different operator inputs which may be used to alter or analyze the node 136 or a group of nodes. These include data including multiple cornering methods 140 which may be selected. A plot decision 142 is entered such as whether a 2D plot or a three-dimensional plot is desired. Multiple time calculations 144 may be entered which allow for example the analyses tool 124 to identify a total time of deposition, for example by layer, an average time of deposition, a time at temperature, a temperature distribution and the like. A code insertion 146 is provided which allows for example movement of lines, and insertion of new instructions. Multiple statistics 148 may also be entered, which may include but are not limited to average temperature at different locations, mean data points, standard deviations of velocities, and the like. Multiple parameters visualizations 150 may be entered which may include but are not limited to print material temperature versus time, a feed rate versus time, and print head velocity versus time. Multiple planning features 152 may also be entered, which may include but are not limited to a material path plan and a trajectory plan. This allows for example to pre-plan print head optimized motion to minimize lost time occurring when the print head must move between rows or layers.

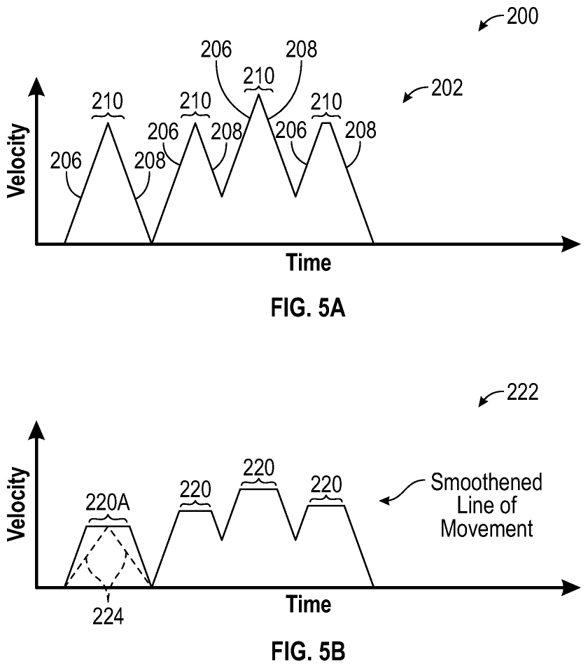

In embodiments, the second portion 138 of the analyses tool 124 also includes a smoothening function 156. The smoothening function 156 is configured to smoothen relatively short movements of the print head 102 (FIG. 2). Referring now to FIGS. 5A and 5B, a graph 200 illustrating an exemplary pattern of short movements 202 by the print head 102 is shown, where the x-axis represents time and the y-axis represents velocity. In the example as shown, the pattern of short movements 202 follow a zigzag pattern. That is, the pattern of short movements 202 follow abrupt alternate up turns 206 and down turns 208, where each set of up and down turns 206, 208 define a move 210. It is to be appreciated that the frequent changes as the print head 102 (FIG. 2) accelerates and decelerates to create the short movements 202 may cause unwanted vibrations. Accordingly, the smoothening function 156 reduces the unwanted vibrations by limiting a top speed of the moves 210 to result in a pattern of modified movements 222, which is shown in FIG. 5B. Specifically, referring to FIGS. 3, 4, and 5A, the analyses tool 124 tracks a normal acceleration rate of the print head 102 as well as a virtual acceleration to deceleration rate of the print head 102 for each move 210 of the pattern of short movements 202.

Referring to FIGS. 3, 4, 5A, and 5B, the smoothening function 156 then calculates a virtual velocity of each move 210 for each move 210, where the virtual velocity is limited to the virtual acceleration to deceleration rate. It is to be appreciated that the virtual acceleration to deceleration rate is half the normal acceleration rate by default. In the example as shown in FIG. 5B, the phantom lines represent a secondary move 224 for a first modified move 220A that is executed using the virtual acceleration to deceleration rate. The smoothening function 156 then determines if the first modified move 220A reaches a full cruising speed using the virtual acceleration to deceleration rate as a top speed of the print head 102. If the first modified move 220A is unable to reach the full cruising speed, then the top speed of the print head 102 is limited to a maximum speed of the virtual acceleration to deceleration rate. In general, because of the relatively short movements, the modified moves 220 seen in FIG. 5B do not reach the full cruising speed, and therefore the top speed of the print head 102 is limited to the maximum speed of the virtual acceleration to deceleration rate. Therefore, as seen in FIG. 5B, this creates a smoothened line of movement.

Referring back to FIGS. 3 and 4, in an embodiment, the second portion 138 of the analyses tool 124 also includes a deceleration planning function 158. The deceleration planning function 158 analyzes the numerical control code to determine if the print head 102 (FIG. 2) fully executes a deceleration. Sometimes the print head 102 may be unable to decelerate in time, especially for relatively short distances. In the event the print head 102 is unable to fully execute a deceleration, then the deceleration planning function 158 reduces the velocity of the print head 102.

In another embodiment, the second portion 138 of the analysis tool includes an initial extrusion analyzer 160. The initial extrusion analyzer 160 calculates a slower acceleration for the print head 102 to compensate for a change in viscoelasticity of the print material as the print head 102 travels during non-print times. Reducing the acceleration may reduce the possibility of jamming due to backflow or increased force of extrusion.

The items entered by the operator or programmer into the second portion 138 of the analyses tool 124 produce one of multiple different print analyses 154. The print analyses 154 individually define projected or estimated conditions of a finished three-dimensional part without the need at this time to run the three-dimensional printer 101. Further optimization of the projected three-dimensional part based on one or more additional print analyses 154 may be conducted by further modifying any of the data entered into the second portion 138 or by e-slicing with different parameters to create a new file to produce further print analyses 154 and comparing results between different print analyses 154.

The analyses tool 124 includes a method to parse numerical control language and identify a machine state at every motion command. The analyses tool 124 allows modification/optimization of the to improve machine performance and part quality. The analyses tool 124 analyzes the numerical control language and allows visibility to statistics of the manufacturing process.

The analyses tool 124 can be used either offline or online. The analyses tool 124 allows path/trajectory simulations. The analyses tool 124 and the method of operation of the analyses tool 124 can be applied to any numerical control language and machine using predetermined machine specifics.

The inputs to the analyses tool 124 are any numerical control language, and the machine parameters for an initial machine conditions may be optionally included. The analyses tool 124 can be used in a single line of numerical control language, in a section of a numerical control language file, or in one or several numerical control language files. The analyses tool 124 analyzes the numerical control language line-by-line and generates information after any motion command, which in an exemplary embodiment is referred to as a node.

The information available at every node includes the state of the machine, the elapsed time for the motion command, and this information can be used for path/trajectory planning and simulations.

An overview of the process of the present disclosure is provided as follows:
1) CAD/CAM software is used to create a part in 3-D;
2) Slicer software is applied to take an output file of the CAD/CAM software and slice it
   up into layers and parameters for a target printer such as a three-dimensional printer;
3) Static analyzer software of the present disclosure takes the numerical control language produced by the slicer software and provides a data analysis to evaluate the performance of the numerical control language on the desired machine;
4) The analysis is used to optimize/improve parameters of the slicer and generate a new numerical control language or to insert numerical control language s to optimize/improve the current numerical control language file; and
5) Printer parsing/optimization: Consumes the optimized numerical control language and queues it up in an optimized fashion for the three-dimensional printer.

The process and method of the present disclosure offers several advantages, including but not limited to three-dimensional printing having a numerical control language with less travel moves which leads to higher throughput and less stringing. The process and method of the present disclosure can also be used to compare files from different slicers, as well as settings that can be changed to decrease a travel time, for example when the extruder is not printing. The process and method of the present disclosure also allows a user to identify an extrusion rate to adjust an extruder temperature. Statistics that can be further obtained for analysis and optimization are extruder velocities, XYZ velocities, average velocities, temperatures, segment lengths, segments distribution and the like. The analysis and optimization of the numerical control language will further yield improved machine performance and part quality. Further, a time required to develop the process parameters to print a part is decreased because it is possible to detect problems and improve the numerical control language before printing a part.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for determining estimated conditions of a finished printed part generated by a three-dimensional printer, the system comprising:
one or more processors for receiving one or more numerical control code files and machine parameters of the three-dimensional printer; and
a memory coupled to the one or more processors, the memory storing data comprising a database and program code that, when executed by the one or more processors, causes the one or more processors to:
parse the one or more numerical control code files into parsed numerical control code files;
determine an updated machine state of the three-dimensional printer based on the parsed numerical control code files and the machine parameters;
combine the updated machine state with the parsed numerical control code files to create one or more nodes;
receive one or more operator inputs that either alter or analyze the one or more nodes; and
create one or more print analyses based on the one or more operator inputs, wherein the one or more print analyses defines the estimated conditions of the finished printed part.

2. The system of claim 1, wherein the one or more nodes includes extractable data indicating a plurality of motion planning parameters of the three-dimensional printer.

3. The system of claim 2, wherein the plurality of motion planning parameters include one or more of the following: a time to produce a line, a quantity of head movements, head direction, time to print the line, and maximum velocities.

4. The system of claim 1, wherein the one or more operator inputs include multiple cornering methods for determining corner velocities.

5. The system of claim 1, wherein the one or more operator inputs include a plot decision that indicates either a two-dimensional plot or a three-dimensional plot.

6. The system of claim 1, wherein the one or more operator inputs include multiple time calculations that include one or more of the following: a total time of deposition, an average time of deposition, a time at temperature, and a temperature distribution.

7. The system of claim 1, wherein the one or more operator inputs include an insertion that provides for one or more of the following: movement of lines, and insertion of new instructions.

8. The system of claim 1, wherein the one or more operator inputs include multiple statistics that include one or more of the following: average temperature at different locations, mean data points, and standard deviation of velocities.

9. The system of claim 1, wherein the one or more operator inputs include multiple parameter visualizations that include at least one of the following: print material temperature versus time, a feed rate versus time, and print head velocity versus time.

10. The system of claim 1, wherein the one or more operator inputs include multiple planning features that include at least one of the following: a material path plan and a trajectory plan.

11. The system of claim 1, wherein the one or more operator inputs include a motion state of the three-dimensional printer over time that include at least one of the following: real velocities, corner velocities, and average velocities per axes or path.

12. The system of claim 1, wherein the one or more operator inputs allow for inspection of the one or more numerical control code files to validate compatibility with the three-dimensional printer.

13. The system of claim 1, wherein the one or more operator inputs include an extrusion rate that includes a relation of the extrusion rate versus extruder temperature.

14. The system of claim 1, wherein the one or more operator inputs include a comparison of a real velocity of a printer head and a commanded velocity of the printer head.

15. The system of claim 1, wherein the one or more operator inputs include a nozzle temperature over time.

16. The system of claim 1, wherein the one or more operator inputs include at least one of the following: an identification of non-ideal temperatures based on a material characterization and an analysis of a non-ideal velocity of a printer head.

17. The system of claim 1, wherein the one or more operator inputs include a smoothening function configured to smoothen relatively short movements of a print head of the three-dimensional printer.

18. The system of claim 1, wherein the one or more operator inputs include a deceleration planning function that analyze the one or more numerical control code files to determine a print head fully executes a deceleration.

19. The system of claim 1, wherein the one or more operator inputs include an initial extrusion analyzer that calculates a slower acceleration for a print head to compensate for a change in viscoelasticity of a print material as the print head travels during non-print times.

20. A method for determining estimated conditions of a finished printed part that is created by a three-dimensional printer, the method comprising:
receiving, by one or more processors, one or more numerical control code files and machine parameters of the three-dimensional printer;
parsing, by the one or more processors, the one or more numerical control code files into parsed numerical control code files;
determining an updated machine state of the three-dimensional printer based on the parsed numerical control code files and the machine parameters;
combining the updated machine state with the parsed numerical control code files to create one or more nodes;
receiving one or more operator inputs that either alter or analyze the one or more nodes; and
creating one or more print analyses based on the one or more operator inputs, wherein the one or more print analyses defines the estimated conditions of the finished printed part.
